(19) United States
(12) Patent Application Publication
(10) Pub. No.: US 2023/0294469 A1
(43) Pub. Date: Sep. 21, 2023

(54) MULTI-TOOL TOW HITCH ASSEMBLY

(71) Applicant: Grant Bell, Santa Clara, CA (US)

(72) Inventor: Grant Bell, Santa Clara, CA (US)

(21) Appl. No.: 18/122,045

(22) Filed: Mar. 15, 2023

Related U.S. Application Data
(60) Provisional application No. 63/319,795, filed on Mar. 15, 2022.

(51) Int. Cl. B60D 1/52; B25F 1/02

(52) U.S. Cl. CPC B60D 1/52; B25F 1/02

(57) ABSTRACT

A multi-tool tow hitch assembly having a handle member with an attachment head member selectively removably and threadedly coupled to the handle member and configured to be selectively removably coupled to a trailer hitch member, a locking nut threadedly coupled to the handle member and operably configured to move longitudinally along a length of the handle member, an upper tool support member having a substantially planar upper surface and having a lower surface, and having a hinge member rotatably coupled to the handle member with a pin and coupled to the lower surface of the upper tool support member with at least one fastener, the upper tool support member operably configured translate into different locking positions to be utilized as a step or a shovel.

### FIELD OF THE INVENTION

The present invention relates generally to vehicle accessories and, more particularly, relates to a multi-tool tow hitch assembly for having multiple structural configurations that can be utilized as tools for a user.

### BACKGROUND OF THE INVENTION

Tow or trailer hitches are operably configured to tow and/or transport cargo, trailers, etc. Generally, a tow hitch, or “hitch receiver mount,” is a device attached to the chassis of a vehicle for towing. The hitch receiver may have a tow ball coupled thereto that allows swiveling and articulation of a trailer, or a tow pin, or a tow hook with a trailer loop.

There are many known device that are configured to transform or be reconfigured into multiple different tools for a user. Very little of those known devices are configured for attachment to a tow hitch. Some known devices, like U.S. Pat. No. 6,769,704 issued to Elegant USA, LLC, are limited to a singular tool, e.g., step, that is configured for attachment to a tow hitch. Said differently, while there are known attachments for a tow hitch, the attachment is configured for a single tool that may be repositioned or oriented relative to the tow hitch. To that end, the existing prior art disadvantageously provides a lack of versatility to users. More specifically, existing tow hitch attachments are typically operably configured to perform only a single function, i.e., to tow or transport cargo, despite the fact that camping and outdoor activities create additional and related needs. Likewise, existing multi-tool systems comprise a variety of attachments that serve many functions except for a towing function.

Therefore, a need exists to overcome the problems with the prior art as discussed above.

### SUMMARY OF THE INVENTION

The invention provides s multi-tool tow hitch assembly having a handle member with a first end, a second end opposite the first end of the handle member, and an attachment head member selectively removably and threadedly coupled to the handle member and configured to be selectively removably coupled to a trailer hitch member, a locking nut threadedly coupled to the handle member and operably configured to move longitudinally along a length of the handle member by selectively rotating the locking nut, an upper tool support member having a substantially planar upper surface, having a lower surface opposing the upper surface of the upper tool support member, having two opposing side walls flanking the lower surface of the upper tool support member, and having a rear wall interposed between the two opposing side walls and flanking the lower surface of the upper tool support member, and having a hinge member rotatably coupled to the handle member with a pin and coupled to the lower surface of the upper tool support member with at least one fastener, wherein the upper tool support member is operably configured to have a first locked configuration with the lower surface of the upper tool support member facing toward the handle member and a second locked position with the upper tool support member extending outwardly from the first end of the handle member and facing away from the handle member and wherein the first and second locked positions are locked with the locking nut.

In accordance with a further feature, the present improvement includes the handle member having a plurality of handle member sections telescopically coupled together.

In accordance with a feature of the present improvement, the first locked configuration includes the handle member includes the attachment head member axially and longitudinally aligned with the handle member.

In accordance with a further feature, the present improvement includes a hammer configuration with the attachment head member solely coupled to the handle member and disposed in a substantially perpendicular angle relative a longitudinal axis of the handle member.

In accordance with yet another feature, the present improvement includes at least one notch formed on the locking nut and at least one protrusion disposed on the attachment head member and shaped and sized to be received within the at least one notch defined on the locking nut.

In accordance with an additional feature of the present improvement, the attachment head member also includes a first end with the least one protrusion disposed proximal thereto and a second end opposing the first end of the attachment head member and with the handle member selectively removably and threadedly coupled thereto.

In accordance with a feature of the present improvement, the two opposing side walls taper in thickness from one end of the upper tool support member toward an opposing end of the upper tool support member.

In accordance with a further feature of the present improvement, the rear wall of the upper tool support member defines a discontinuous notch shaped and sized to receive a portion of the handle member.

In accordance with another feature of the present improvement, the discontinuous notch is centrally located on the rear wall of the upper tool support member.

In accordance with yet another feature, the present improvement includes the handle member having two opposing discontinuous slots spanning longitudinally from the first end of the handle member.

In accordance with an exemplary feature, the present improvement includes an axe head member selectively removably coupled to the lower surface of the upper tool support member and have an end tapered in thickness to a point.

In accordance with another feature, the present improvement also includes the hinge member having two opposing locking detents selectively displaceable and removably coupled to the axe head member and configured to be received within a plurality of notches, the axe head member defining a plurality of enclosed channels shaped and sized to receive hinge member.

In accordance with yet another feature, the present improvement includes the axe head member having an aperture shaped and sized to receive a secondary pin therethrough, the axe head member shaped and sized to be received within the two opposing discontinuous slots and operably configured to have an axe configuration relative to the handle member and be retained in a locked orientation relative to the handle member with the locking nut.

In accordance with yet another feature, the present improvement includes a locking washer defining an enclosed aperture with the handle member disposed therein and interposed between the locking nut and the axe head member when in the axe configuration.

In accordance with an additional feature, the present improvement includes a locking washer defining an enclosed aperture with the handle member disposed therein and interposed between the locking nut and the hinge member.

Although the invention is illustrated and described herein as embodied in a multi-tool tow hitch assembly, i.e., an assembly couplable to a tow hitch, it is, nevertheless, not intended to be limited to the details shown because various modifications and structural changes may be made therein without departing from the spirit of the invention and within the scope and range of equivalents of the claims. Additionally, well-known elements of exemplary embodiments of the invention will not be described in detail or will be omitted so as not to obscure the relevant details of the invention.

Also in accordance with the present invention and in combination with a trailer hitch member coupled to a vehicle and defining a tube for receiving a shank of a tow assembly an improvement is disclosed that includes a handle member with a first end, a second end opposite the first end of the handle member, and an attachment head member selectively removably and threadedly coupled to the handle member and inserted within the tube of the trailer hitch member, a locking nut threadedly coupled to the handle member and operably configured to move longitudinally along a length of the handle member by selectively rotating the locking nut, an upper tool support member having a substantially planar upper surface, having a lower surface opposing the upper surface of the upper tool support member, and a hinge member rotatably coupled to the handle member with a pin and coupled to the lower surface of the upper tool support member with at least one fastener, wherein the upper tool support member is operably configured to have a first locked configuration with the lower surface of the upper tool support member facing toward the handle member and the substantially planar upper surface elevated above the tube and a second locked position with the handle member removed from the tube of the trailer hitch member and with the upper tool support member extending outwardly from the first end of the handle member and facing away from the handle member, the first and second locked positions locked with the locking nut.

Other features that are considered as characteristic for the invention are set forth in the appended claims. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one of ordinary skill in the art to variously employ the present invention in virtually any appropriately detailed structure. Further, the terms and phrases used herein are not intended to be limiting; but rather, to provide an understandable description of the invention. While the specification concludes with claims defining the features of the invention that are regarded as novel, it is believed that the invention will be better understood from a consideration of the following description in conjunction with the drawing figures, in which like reference numerals are carried forward. The figures of the drawings are not drawn to scale.

Before the present invention is disclosed and described, it is to be understood that the terminology used herein is for the purpose of describing particular embodiments only and is not intended to be limiting. The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “substantially” is defined as entirely, 90% or greater, or another interpretation reasonably ascertainable by a person of skill in the art. Even if the term “substantially” is removed as a modifier for any term, it may be still be interpreted as such to maintain the clarity and breadth of the claims as intended. The term “coupled,” as used herein, is defined as connected, although not necessarily directly, and not necessarily mechanically. The term “providing” is defined herein in its broadest sense, e.g., bringing/coming into physical existence, making available, and/or supplying to someone or something, in whole or in multiple parts at once or over a period of time. Also, for purposes of description herein, the terms “upper”, “lower”, “left,” “rear,” “right,” “front,” “vertical,” “horizontal,” and derivatives thereof relate to the invention as oriented in the figures and is not to be construed as limiting any feature to be a particular orientation, as said orientation may be changed based on the user's perspective of the device. Furthermore, there is no intention to be bound by any expressed or implied theory presented in the preceding technical field, background, brief summary or the following detailed description.

As used herein, the terms “about” or “approximately” apply to all numeric values, whether or not explicitly indicated. These terms generally refer to a range of numbers that one of skill in the art would consider equivalent to the recited values (i.e., having the same function or result). In many instances these terms may include numbers that are rounded to the nearest significant figure. In this document, the term “longitudinal” should be understood to mean in a direction corresponding to an elongated direction of the handle member or, said another way, in a direction to and from opposing ends of the handle member.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and explain various principles and advantages all in accordance with the present invention.

FIG. 1 is an exploded view of a multi-tool tow hitch assembly in accordance with one embodiment of the present invention;

FIG. 2 is a perspective top view of the multi-tool tow hitch assembly depicted to FIG. 1, assembled in a first configuration;

FIG. 3 is an elevational side view of the multi-tool tow hitch assembly depicted to FIG. 2;

FIG. 4 is a bottom plan view of the multi-tool tow hitch assembly depicted to FIG. 2;

FIG. 5 is an elevational front view of the multi-tool tow hitch assembly depicted to FIG. 2;

FIG. 6 is a perspective view of a hinge assembly utilized with the multi-tool tow hitch assembly in accordance with one embodiment of the present invention;

FIG. 7 is an elevational side view of the hinge assembly depicted in FIG. 6;

FIG. 8 is an elevational side view of an attachment head coupled to a handle member and forming a hammer configuration with the multi-tool tow hitch assembly in accordance with one embodiment of the present invention;

FIG. 9 is a perspective view of an attachment head assembly utilized with the multi-tool tow hitch assembly in accordance with one embodiment of the present invention;

FIG. 10 is an elevational side view of an axe head coupled to a handle member and forming an axe configuration with the multi-tool tow hitch assembly in accordance with one embodiment of the present invention;

FIG. 11 is an elevational rear view of the axe configuration depicted in FIG. 10;

FIG. 12 is a perspective view of a washer utilized with the multi-tool tow hitch assembly in accordance with one embodiment of the present invention;

FIG. 13 is a perspective view of an axe head utilized with the multi-tool tow hitch assembly in accordance with one embodiment of the present invention;

FIG. 14 is an elevational rear view of an axe head coupled to a handle member and forming a hoe configuration with the multi-tool tow hitch assembly in accordance with one embodiment of the present invention;

FIG. 15 is an elevational side view of the axe configuration depicted in FIG. 14;

FIGS. 16-18 depict perspective and overhead views of the multi-tool tow hitch assembly forming a stool configuration in accordance with one embodiment to the present invention;

FIGS. 19-20 depict perspective and side elevational views, respectively, of the multi-tool tow hitch assembly in a shovel configuration with the axe head member uncoupled to the hinge member in accordance with one embodiment of the present invention; and

FIGS. 21-22 depict perspective and side elevational views, respectively, of the multi-tool tow hitch assembly in a shovel configuration with the axe head member coupled to the hinge member in accordance with one embodiment of the present invention.

### DETAILED DESCRIPTION

While the specification concludes with claims defining the features of the invention that are regarded as novel, it is believed that the invention will be better understood from a consideration of the following description in conjunction with the drawing figures, in which like reference numerals are carried forward. It is to be understood that the disclosed embodiments are merely exemplary of the invention, which can be embodied in various forms.

The present invention provides a novel and efficient multi-tool hitch assembly that is operably configured to structurally transform and function into multiple tools that can address a variety of needs to users partaking in outdoor recreational or commercial activities. The present invention may provide a heavy-duty multi-tool assembly couplable to a tow hitch that converts into, by way of example and without limitation, a shovel, a hammer, an axe, a step, a hoe, and a stool via interchangeable attachment heads, for camping, outdoors and 4×4 off-road applications. Embodiments of the invention also includes a hitch assembly designed to conveniently slide into a tow hitch receiver of any vehicle, e.g., a tow hitch having a diameter of approximately 1-2″. When stored and locked in the tow hitch receiver, the assembly may function as a step to help users retrieve items stored in the truck bed, or the roof storage of the vehicle. The present invention may also be mounted in other locations with the use of a mounting bracket.

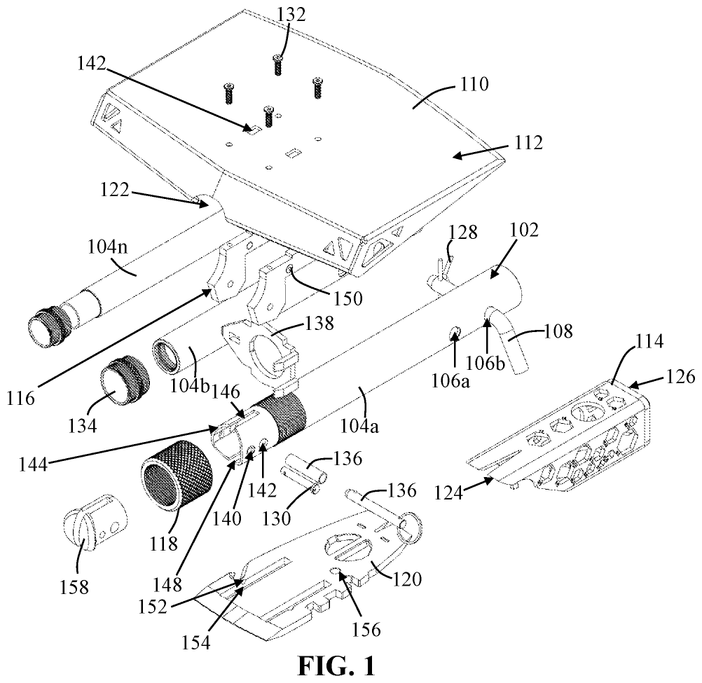

Referring now to FIG. 1, one embodiment of the present invention is shown in a perspective front view. FIG. 1 shows several advantageous features of the present invention, but, as will be described below, the invention can be provided in several shapes, sizes, combinations of features and components, and varying numbers and functions of the components. The first example of a novel and efficient multi-tool tow hitch assembly 100 (hereinafter referred to as “assembly 100” for brevity) is depicted in FIG. 1. Embodiments of the invention provide an assembly 100 that is operably configured to selectively and removably couple various attachment tool heads and form various tool configurations (e.g., a shovel, a hammer, an axe, a step, a stool, etc.). The assembly 100 can form multiple structures and serve a multitude of functions depending on the type of attachment tool head attached thereto (e.g., to shovel, to hammer, to cut down, to step on, to sit on, to tow, etc.). An exploded view of the assembly 100 is depicted in FIG. 1.

Referring now to FIG. 1, the assembly 100 comprises a handle member 102 that may have a plurality of telescopically connected handle member sections 104a-n (wherein “n” refers to any number greater than one). The handle member sections 104a-n may be threadedly couplable with one another in the telescopic recessed configuration (to inhibit vibration) and also threadedly couplable with one another in the telescopic extended configuration by reversing the orientation of the handle member sections 104a-n relative to one another. The extension of the handle member 102 with the telescopic handle member sections 104a-n beneficially provides a user with a longer handle beneficial for handling and using tools or a handle member with a wider grip or wider surface diameter for gripping. The handle member sections 104a-n can be seen formed with different diameters, e.g., a large diameter, an intermediate diameter, and a small diameter handle member section, wherein each handle member section may have a threaded end (that may be removable, see, for example, removable threaded end member 134).

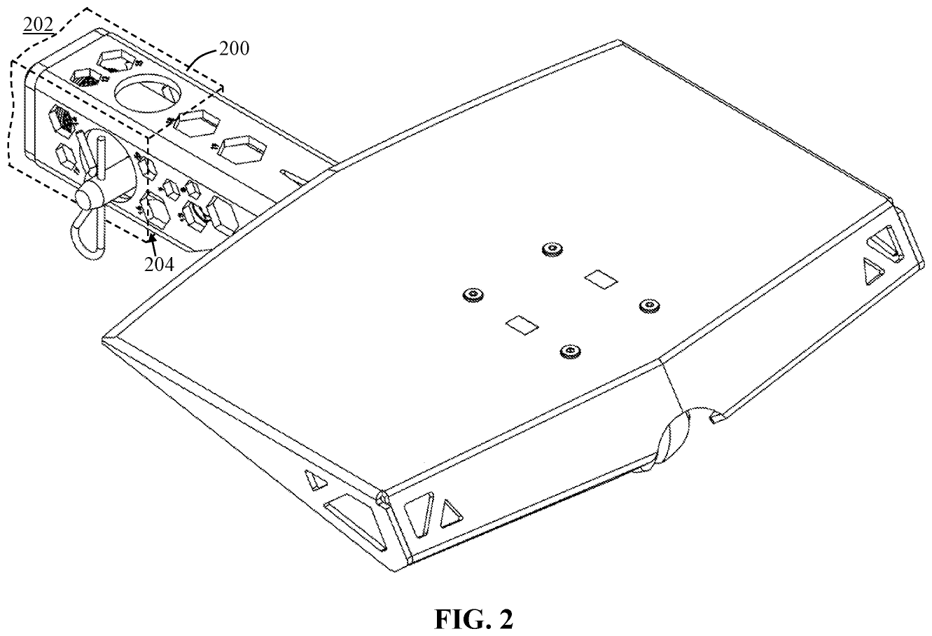

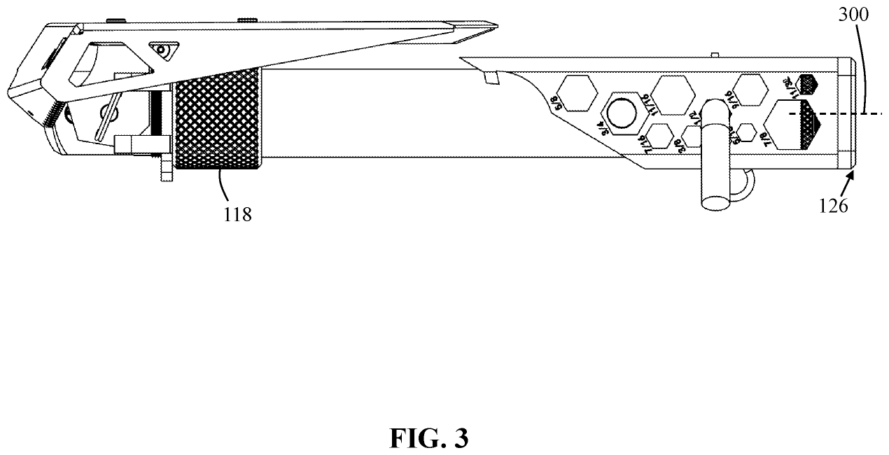

At least one of the sections 104a-n, but preferably each of the sections 104a-n, have a plurality of through holes or apertures 106a-n shaped, sized, and configured to receive a pin 108, wherein the sections 104a-n are configured, when in the telescopic recessed configuration, have the apertures 106a-n formed on each of the sections 104a-n aligned with one another. One or more of the sections 104a-n, preferably the large handle member section 104a has an attachment head 114 directly coupled thereto, wherein the attachment head member 114 is formed with a substantially rigid material, e.g., aluminum or stainless steel, and is beneficially shaped and sized to be received within a tow hitch 200 of a vehicle 202. More specifically, the user may insert the attachment head 114 into the receiver tube 204 of the tow hitch 200 and then insert the pin 108 therethrough and the apertures 106a-n one or more handle member sections 104a-n to lock the tool in the hitch 200 of the vehicle 202 (i.e., the “transport position” or “transport configuration”). In one embodiment (as best seen in FIGS. 2-3) attachment head 114 is coupled to the handle member 102 with the pin 108, wherein the attachment head 114 may have a plurality of through holes for receiving the pin 108, thereby beneficially enabling the upper tool support member 110 (or step) to be brought closer or extended farther from the vehicle 202. In one embodiment, the handle member 102 includes a plurality of through holes 106a-b for receiving the pin 108 operably configured to be inserted therethrough and retained with, for example, a cotter or clevis pin 128.

Beneficially, the attachment head 114 is shaped and sized to be inserted into the tow hitch receiver 200 of a vehicle 202 (representatively depicted) in a snug or tightly spaced configuration, i.e., within 0.5″ variance (as exemplified in FIG. 2). The attachment head 114 is advantageously formed with one or more through holes or apertures 106 and includes two opposing ends 124, 126. The second end 126 may include a substantially planar and rigid surface, e.g., hardened steel, (for hammering) and the first end 124 tapered or angled to form a point or edge surface (for chipping or digging, like a pickaxe). To that end, the first end 124 may be formed to a sharped edge and include a V-shape notch formed thereon for, by way of example, removing nails. The attachment head 114 is preferably selectively removably couplable to the handle member 102 on the second end 126 thereon. The second 126 may include a handle aperture defined thereon that may be enclosed and is threaded. The attachment head 114 is selectively removably and threadedly couplable to the handle member 102 using, for example, a threaded configuration and/or more locking nuts. To effectuate the same, the user may insert the handle member 102 through an opening and channel defined by the attachment head 114 and threadedly couple the handle member 102 to attachment head 114 proximal to the second end 125. The handle member 102 is operably configured to have a first hitch attachment configuration (shown in FIGS. 2-3) with the attachment head 114 axially and longitudinally aligned with the handle member 102 and a second hammer configuration (shown in FIG. 6) with the attachment head 114 disposed in a substantially perpendicular angle (90°+/−10°) relative a longitudinal axis (exemplified with axis 300 in FIG. 3) of the handle member 102. Again, the locking nut 118 may be beneficially utilized to apply a heighted torque and pressure to the washer 138 and to safely secure the handle member 102 to the attachment head 114 or axe head member 120.

In one embodiment, the handle member 102 beneficially includes a locking nut 118 that is operably configured to be placed over an end of the handle member 102 and threadedly couple to the handle member 102, namely the handle member section 104a, along a length thereof. More specifically, the user will selectively raise and lower the locking nut 118 along the length of the handle member 102 to selectively apply increased torque and pressure against a specially configured washer 138 that supplies pressure against the hinge assembly 116 or other structure. This selectively pressure reduces the likelihood of noise and vibration of the upper support member 110 (or other attachment), also referred to herein as a “shovel head” 110 or “step” 110 (depending on the configuration of the upper support member 110 relative to the handle member 102).

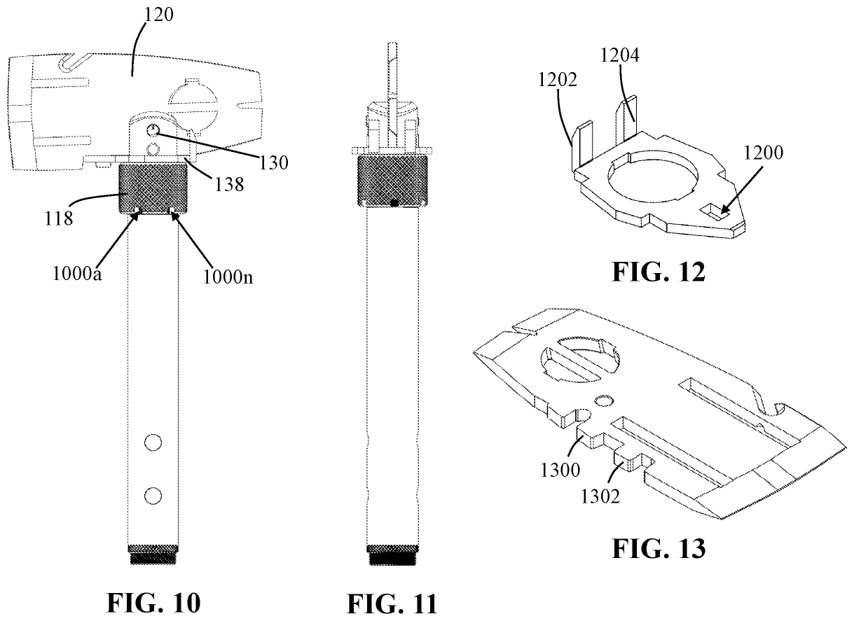

As best seen in FIGS. 9-10, the locking nut 118 may include one or more notches 1000a-n disposed around a periphery of the locking nut 118, preferably around a distal and perimeter edge thereon. The attachment head 114 may also include one or more protrusions 900, 902 that are spaced relative and equal to the spacing of the notches 1000a-n and also shaped and sized to be received within the notches 1000a-n, thereby enabling a user to selectively apply a heighten torque to the locking nut 118 onto the washer 138 or other structure. To effectuate the same, the attachment head 114 also includes one or more arcuate portions (e.g., portion 904 shaped to conform to the curvature of the locking nut 118) spanning from the protrusion(s) 900, 902 to a stop or secondary point (e.g., stop 906) that is configured to engage with the surface of the locking nut 118. Said differently, with reference to FIG. 1 and FIGS. 9-10, the attachment head 114 may include a first end 124 with one or more protrusion(s) 900, 902 disposed proximal thereto and a second end 126, opposing the first end 124. The second end 126 may have a configuration with the handle member 102 selectively removably and threadedly coupled thereto (exemplified in FIG. 3). The term “proximal” is defined as directly contacting, directly coupling with, or near (within 5% of the overall structure). The threaded coupling configuration between the handle member 102 and the attachment head 114 provides stability for attachment and use with the trailer hitch member 200.

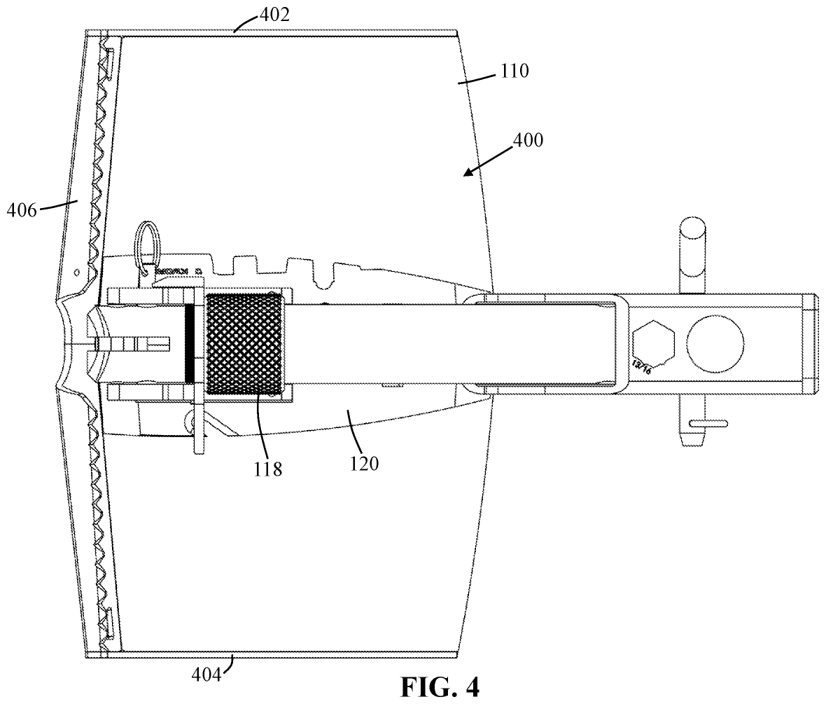

With reference to FIG. 1 and FIG. 4, the handle member 102 is rotatably coupled to the upper tool support member 110 (or shovel member) with a hinge assembly 116. In one embodiment, the hinge assembly 116 includes two hinge members 600, 602 directly coupled to the upper tool support member 110 with one or more fastener(s) 132 and rotatably coupled to the handle member 102 with a pin 136 or pin 130 that is inserted through an aperture or through hole 140, 142 formed on the handle member 102 and located proximal to the end of the handle member. The pin 136 may be advantageously coupled to the lower surface 400 or other portion of the tool support member 110 with a flexible tether to prevent misplacement or loss of the pin 136. To completely remove the upper tool support member 110 from the handle member 102, the user may selectively lower the locking nut 118 and remove the pin 136 from the aperture 142. The upper tool support member 110 may beneficially have a substantially planar surface 112 on an upper surface thereon. The substantially planar surface may span the entire surface defined by perimeter edges of the upper tool support member 110.

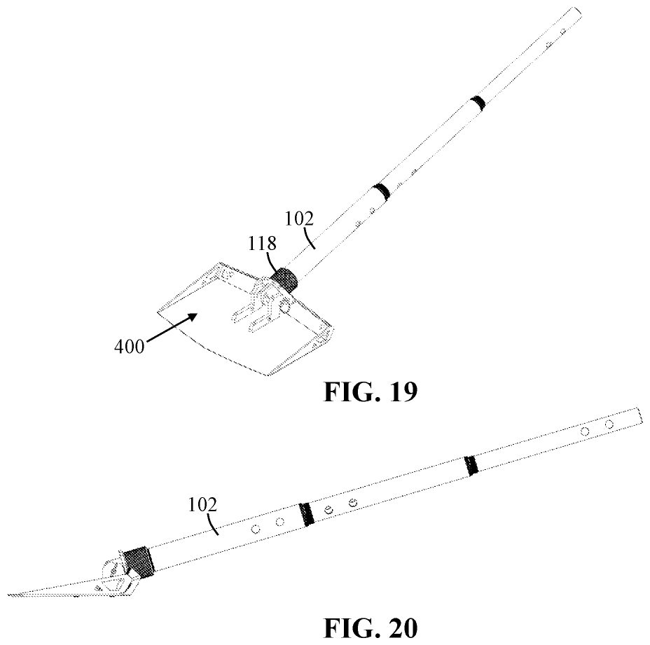

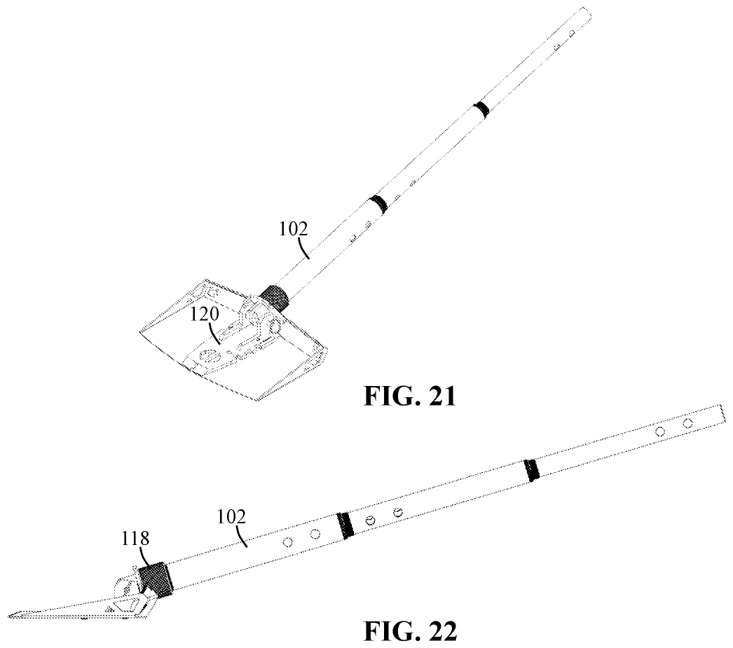

In one embodiment, the upper tool support member 110 is configurable as a shovel by selectively lowering the locking nut 118 and allowing rotation of the upper tool support member 110 in an orientation that is not substantially overlapping or covering the handle member 102. Rather, the shovel configuration would include the upper tool support member 110 being substantially longitudinally aligned or axially aligned with the handle member 102 and lockable in said orientation or configuration by selectively raising the locking nut 118 to apply pressure to the washer 138. FIGS. 19-22 depict the shovel configuration, wherein FIGS. 19-20 depict the shovel configuration with the axe-member 120 removed (as discussed herein) and FIGS. 21-22 depict the shovel configuration with the axe member 120 still selectively removably coupled to the hinge member 116. The hinge assembly 116 rotatably coupling the upper tool support member 110 to the handle member 102 may consist of one or more hinge members 600, 602 (exemplified in FIGS. 6-7). The upper tool support member 110 is directly coupled to the hinge members 600, 602 with multiple fasteners that are inserted through the top surface 112, through the support member 110 and into apertures formed on the top surface of the hinge members 600, 602. To ensure proper orientation of the hinge members 600, 602 and alignment of the apertures for fasteners 132 relative to support member 110, the hinge member(s) 600, 602 may include centrally disposed protrusions 1300, 1302 configured, shaped, and sized to be inserted through specially formed and similarly shaped apertures (e.g., aperture 142) also formed on and through the support member 110. The handle member 102 also beneficially defines two opposing discontinuously slots 146, 148 that span longitudinally from a distal edge of the handle member 102 along the handle member length. The slots 146, 148 are shaped and sized to receive the axe head 120.

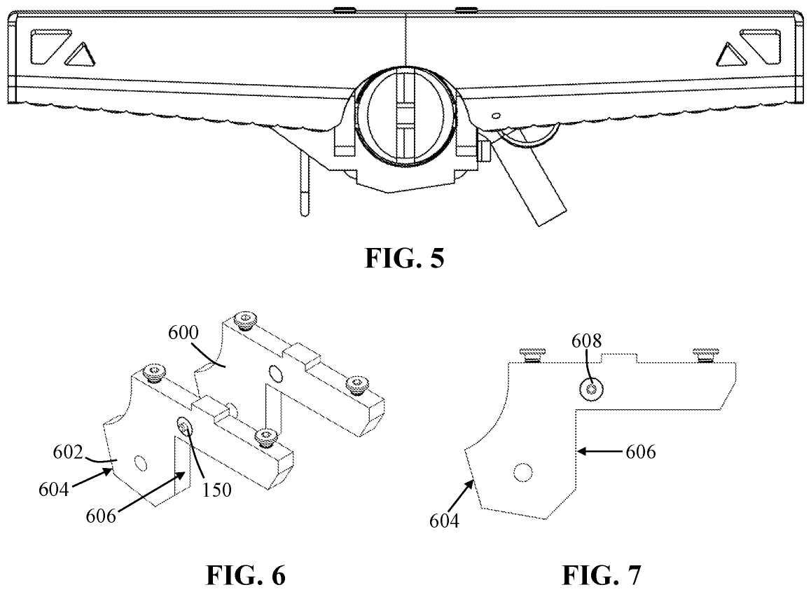

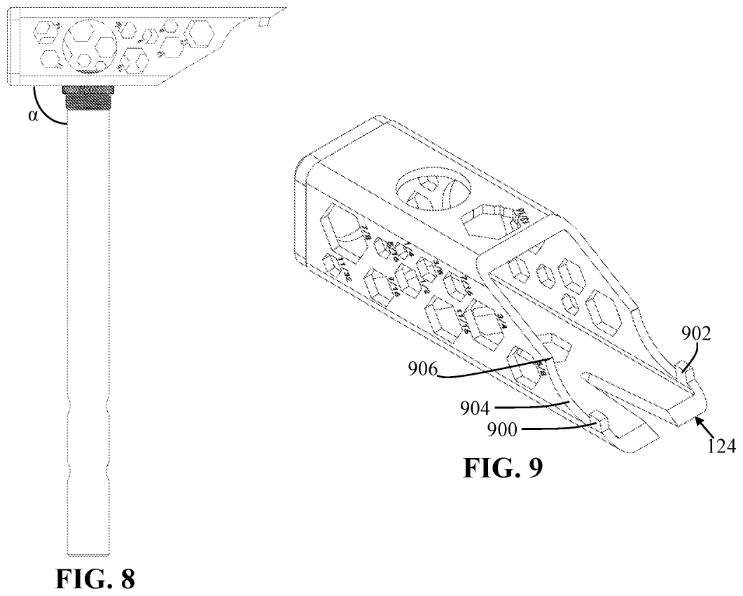

When configured as a shovel head, the opposing side walls 402, 402 of the upper tool support member 110 taper in thickness from one end of the upper tool support member 110 toward an opposing end of the upper tool support member 110. In one embodiment, the tapering is continuous and runs the entire longitudinal length thereon. The shovel head 110 may include a centrally located circular aperture or notch 122 for receiving one or more of the nuts and/or handle member 102. Said differently, an edge of the tool support member 110 includes a cutout or notch shaped and sized to receive a portion or all of the handle member 102. Additionally, to unlock the upper tool support member 110 from the step configuration (exemplified in FIGS. 2-5) and freely rotate the support member 110, the user may be required to unlock the locking nut 118 from the washer 138. The notch 112 formed on the rear wall of the upper tool support member 110 is discontinuous in that it does not extend the entire length of support member 110 and is preferably arcuate in shape to contour or receive a portion of the handle member 102. The discontinuous notch 122 is preferably a total depth equal or slightly greater (10%) the max diameter of the handle member 102 and is centrally located on the rear wall 406 of the upper tool support member 110, i.e., located at least partially along a geometric midpoint line of the upper tool support member 110.

The hinge assembly 116 may be coupled with the underside or lower surface 400 of the shovel head 110, opposing the upper planar surface 112, using one or more fasteners (exemplified in FIG. 1) and have another end coupled with the handle member 102. The hinge assembly 116 is operable to enable the shovel head 110 to rotate from a step position or step configuration (exemplified in FIG. 2) to a shovel position or shovel configuration that is longitudinally aligned with the handle member 102 and disposed in front of an end 144 of the handle member 102. To that end, the shovel head 110 has sidewalls 402, 404 on opposing sides of the upper surface 112 and on a rear wall 406 (defining the cutout 122), thereby enabling the walls and lower surface to be utilized as a shovel. The hinge assembly 116 may also be selectively uncoupled and coupled to the handle member 102 by removing the pin 136. As best seen in FIG. 4, the upper edge of the rear wall 406 may also include jagged and/or undulating surfaces forming a rake (depending on the attached orientation). To advantageously lock the upper tool support member 110 in the step/rake configuration or the shovel orientation, the hinge members 600, 602 are formed with flattened surfaces, e.g., surfaces 604, 606. The surfaces 604, 606 are beneficially planar to increase contacting surface area with the washer 138, wherein the surface 604 will directly contact the washer 138 when in the shovel orientation and beneficially creates an angle desired for shoveling and the surface 606 will directly contact the washer 138 when in the step, seat, or rake. For example, FIG. 20 depicts the hinge members 600, 602 creating a desired angle (e.g., 10-20°) relative between the lower surface 400 and the handle member 102.

When the axe head member 120 is stored away and not desired to be utilized by the user, it is beneficially and safely selectively removably coupled to the lower surface 400 of the upper tool support member 110. In one embodiment, to ensure safe and secure transport, the hinge member 116, e.g., the two hinge members 600, 602, each have two opposing locking detents 150, 608 selectively displaceable for the user to couple and uncouple the axe head member 120 to the upper tool support member 110, wherein, when coupled, it is substantially parallel and adjacent to the lower surface 400. The two opposing locking detents 150, 608 are configured to be received within a plurality of notches (e.g., notch 152) on the axe head member 120 and retained thereon by virtue of the structural configuration of the axe head member 120 defining the notches 152. To ensure the axe head member 120 lays flat on the lower surface 400, the axe head member 120 defines one or more enclosed channel(s) (e.g., channel 154) shaped and sized to receive hinge member(s) 116, respectively. This structural configuration is best shown in FIG. 6.

The axe head member 120 also beneficially includes an aperture (e.g., aperture 156) shaped and sized to receive a secondary pin 130 therethrough, wherein the axe head member 120 is shaped and sized to be received within the two opposing discontinuous slots 146, 148 and operably configured to be retained in a locked orientation relative to the handle member 102 with the locking nut 118 (see, for example, FIGS. 10-11). The washer 138 also advantageously enables the locking nut 118 to selectively apply pressure to the axe head member 120 to retain it on the handle member 102. The secondary pin 130 prevents longitudinal movement of the axe head member 120 when inserted through the enclosed aperture 156, thereby causing the axe head member 120 to stay securely fastened to the handle member 102. To effectuate the attachment of the axe head member 120 to the handle member 102 in the correct orientation, the washer 138 has a center enclosed aperture 1200 that is shaped and sized to receive (and contour) one of the protrusions 1300, 1302 of the axe head member 1200 (best seen exemplified in FIGS. 12-13).

As seen in the figures, the secondary pin 130 has many advantageous features and functions, as it is designed to restrict longitudinal movement of tools attached to the handle member 102. In one embodiment, it is designed to selectively moved back-and-forth, but not be removed unless a notch is aligned with a channel defined on the handle member 102, i.e., it is able to be displaced or moved a length to provide access to the channel defined by the handle member 102 and the slots 146, 148 and displaced or moved into a position that restricts longitudinal movement of a tool or other structure through the channel defined by the handle member 102 or slots 146, 148. In one embodiment, the secondary pin 130 is lockable within the aperture 156 unless specifically unlocked by the user, e.g., by rotating the secondary pin 130 or removing one or more fasteners, e.g., a cotter pin.

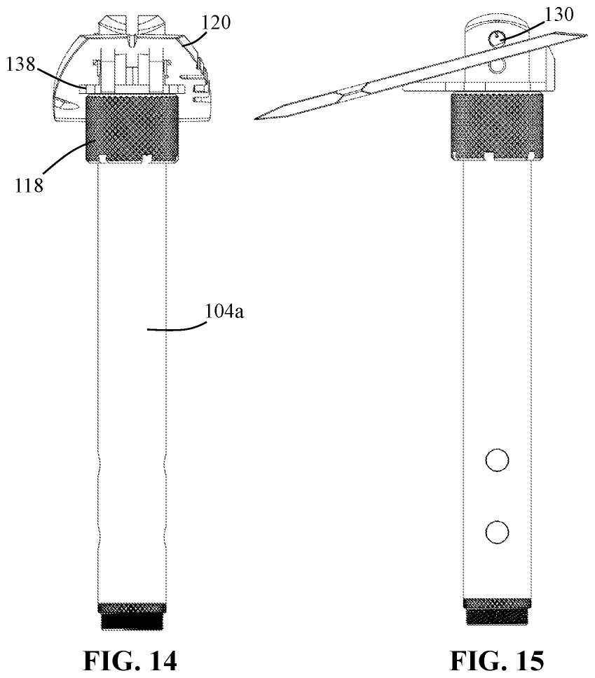

Referring back to FIGS. 1-2, the tow hitch receiver portion 200 may be of a rectangular shape, wherein the attachment head member 114 is designed to slide into the tow hitch tube 204. In an exemplary embodiment, the telescopically connected sections 104a-n consist of a 3-lung aluminum or steel tube handle, i.e., one large handle 104a and two increasingly smaller handle members 104b, 104c, which telescopically nest into each other. At the top of the largest handle 104a is the hinge assembly 116, which may allow for the attachment and rotation of attachment tool heads. Each smaller handle member has threaded ends, which allow for the nesting and securing of the handles as well at the attachment of tools. Beneficially, this feature enables a user to selectively vary the length of the handle member 102 among three handle length options. When in the closed position, the assembly 100 can be used as a step for reaching into the back of trucks, or up to the roof of vehicles, while in the vehicle's tow hitch. Once removed and opened, the assembly 100 can be used in a multitude of ways. These include but are not limited to a hardened aluminum or steel sand and snow shovel, full size tow hitch step when closed; hammer with peg/nail puller, tow hitch receiver adapter; adjustable hoe, trench digger; converts to a camp stool; rake/camp clearing tool; pry bar; and nail puller; axe. The assembly 100 may also comprise other helpful features such as, without limitation, markings for ruler, angle measure and fish ruler and a spanner with 12 Standard Imperial & 13 standard Metric that are formed on the attachment head member 114. For example, with reference to FIGS. 14-15, a hoe configuration is depicted, wherein the handle member 104a—is coupled to the washer 138, which applies pressure, via the locking nut 118, to the axe head member 120 that is oriented transversely or horizontally at an angle of approximately 70-80° relative to the orientation of the handle member 104a. Beneficially, the washer 138 can be seen having two projecting fingers or prongs 1202, 1204 (exemplified best in FIG. 12) that the support the axe head member 120 in the angular orientation. The axe head member 120 is longitudinally retrained by the secondary pin 130 (after inserted through the handle member 104a defining the slots 146, 148), wherein the axe head member 120 is transversely retained by the handle member 104a. The axe head member 120 may be reversed to create a pry bar, nail puller, etc.

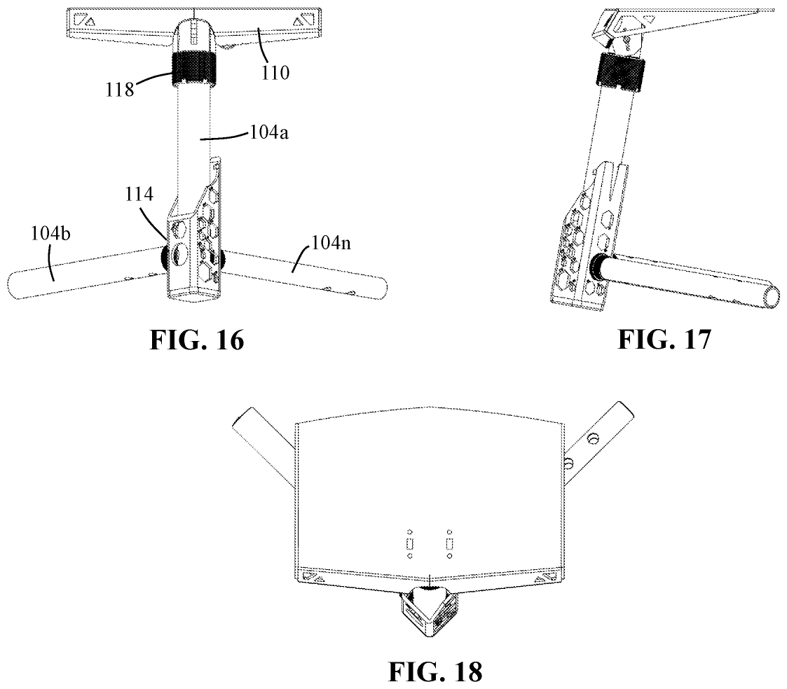

Exemplary embodiments of the assembly 100 are of a high-quality aluminum or steel composition to beneficially provide the structural and physical support needed to perform the various functions, e.g., to serve as a stool, a step, a tow, etc. Exemplary dimensions of the assembly 100 and the components therein are reflected in the attached figures. The figures also depict beneficially coupling configurations for the tools depicted therein and form inventive features of the present invention. For example, FIGS. 16-18 depict perspective and overhead views of the multi-tool tow hitch assembly forming a stool configuration, wherein the handle members 104a-n are selectively removably and threadedly coupled to the head attachment member 114 (as depicted) to create a base and an upright support member for supporting a seat, i.e., the upper tool support member 110 that generates a substantially planar seating surface for a user.

In an exemplary embodiment, a tube cap 158, with apertures, is selectively removably couplable to the first end 144 of the handle member 102 and ensures debris and other material is not inadvertently inserted inside of the channel defined by the handle member 104a and protecting the other handle members 104b-c.

Various modifications and additions can be made to the exemplary embodiments discussed without departing from the scope of the present disclosure. For example, while the embodiments described above refer to particular features, the scope of this disclosure also includes embodiments having different combinations of features and embodiments that do not include all of the above-described features.

What is claimed is:

1. A multi-tool tow hitch assembly comprising:
a handle member with a first end, a second end opposite the first end of the handle member, and an attachment head member selectively removably and threadedly coupled to the handle member and configured to be selectively removably coupled to a trailer hitch member;
a locking nut threadedly coupled to the handle member and operably configured to move longitudinally along a length of the handle member by selectively rotating the locking nut;
an upper tool support member having a substantially planar upper surface, having a lower surface opposing the upper surface of the upper tool support member, having two opposing side walls flanking the lower surface of the upper tool support member, and having a rear wall interposed between the two opposing side walls and flanking the lower surface of the upper tool support member; and
a hinge member rotatably coupled to the handle member with a pin and coupled to the lower surface of the upper tool support member with at least one fastener, the upper tool support member operably configured to have a first locked configuration with the lower surface of the upper tool support member facing toward the handle member and a second locked position with the upper tool support member extending outwardly from the first end of the handle member and facing away from the handle member, the first and second locked positions locked with the locking nut.

2. The multi-tool tow hitch assembly according to claim 1, wherein the handle member further comprises:
a plurality of handle member sections telescopically coupled together.

3. The multi-tool tow hitch assembly according to claim 1, wherein first locked configuration includes the handle member includes the attachment head member axially and longitudinally aligned with the handle member.

4. The multi-tool tow hitch assembly according to claim 1, further comprising a hammer configuration with the attachment head member solely coupled to the handle member and disposed in a substantially perpendicular angle relative a longitudinal axis of the handle member.

5. The multi-tool tow hitch assembly according to claim 1, further comprising:
at least one notch formed on the locking nut; and
at least one protrusion disposed on the attachment head member and shaped and sized to be received within the at least one notch defined on the locking nut.

6. The multi-tool tow hitch assembly according to claim 5, wherein the attachment head member further comprises:
a first end with the least one protrusion disposed proximal thereto and a second end opposing the first end of the attachment head member and with the handle member selectively removably and threadedly coupled thereto.

7. The multi-tool tow hitch assembly according to claim 1, wherein two opposing side walls taper in thickness from one end of the upper tool support member toward an opposing end of the upper tool support member.

8. The multi-tool tow hitch assembly according to claim 1, wherein the rear wall of the upper tool support member defines a discontinuous notch shaped and sized to receive a portion of the handle member.

9. The multi-tool tow hitch assembly according to claim 8, wherein the discontinuous notch is centrally located on the rear wall of the upper tool support member.

10. The multi-tool tow hitch assembly according to claim 1, wherein the handle member further comprises:
two opposing discontinuous slots spanning longitudinally from the first end of the handle member.

11. The multi-tool tow hitch assembly according to claim 10, further comprising:
an axe head member selectively removably coupled to the lower surface of the upper tool support member and have an end tapered in thickness to a point.

12. The multi-tool tow hitch assembly according to claim 11, wherein the hinge member further comprises:
two opposing locking detents selectively displaceable and removably coupled to the axe head member and configured to be received within a plurality of notches, the axe head member defining a plurality of enclosed channels shaped and sized to receive hinge member.

13. The multi-tool tow hitch assembly according to claim 11, wherein the axe head member further comprises:
an aperture shaped and sized to receive a secondary pin therethrough, the axe head member shaped and sized to be received within the two opposing discontinuous slots and operably configured to have an axe configuration relative to the handle member and be retained in a locked orientation relative to the handle member with the locking nut.

14. The multi-tool tow hitch assembly according to claim 13, further comprising:
a locking washer defining an enclosed aperture with the handle member disposed therein and interposed between the locking nut and the axe head member when in the axe configuration.

15. The multi-tool tow hitch assembly according to claim 1, further comprising:
a locking washer defining an enclosed aperture with the handle member disposed therein and interposed between the locking nut and the hinge member.

16. In combination with a trailer hitch member coupled to a vehicle and defining a tube for receiving a shank of a tow assembly, the improvement comprising:
a handle member with a first end, a second end opposite the first end of the handle member, and an attachment head member selectively removably and threadedly coupled to the handle member and inserted within the tube of the trailer hitch member;
a locking nut threadedly coupled to the handle member and operably configured to move longitudinally along a length of the handle member by selectively rotating the locking nut;
an upper tool support member having a substantially planar upper surface, having a lower surface opposing the upper surface of the upper tool support member; and
a hinge member rotatably coupled to the handle member with a pin and coupled to the lower surface of the upper tool support member with at least one fastener, the upper tool support member operably configured to have a first locked configuration with the lower surface of the upper tool support member facing toward the handle member and the substantially planar upper surface elevated above the tube and a second locked position with the handle member removed from the tube of the trailer hitch member and with the upper tool support member extending outwardly from the first end of the handle member and facing away from the handle member, the first and second locked positions locked with the locking nut.

17. The improvement according to claim 16, wherein the upper tool support member further comprises:
two opposing side walls flanking the lower surface of the upper tool support member; and
a rear wall interposed between the two opposing side walls and flanking the lower surface of the upper tool support member.

18. The improvement according to claim 16, further comprising:
a locking washer defining an enclosed aperture with the handle member disposed therein and interposed between the locking nut and the hinge member.
